(19) United States
(12) Patent Application Publication
(10) Pub. No.: US 2025/0370213 A1
(43) Pub. Date: Dec. 4, 2025

(54) LENS UNIT

(71) Applicant: NIDEC INSTRUMENTS CORPORATION, Nagano (JP)

(72) Inventor: Takuya KASAHARA, Nagano (JP)

(21) Appl. No.: 19/223,031

(22) Filed: May 30, 2025

(30) Foreign Application Priority Data
May 31, 2024 (JP) 2024-088766

(51) Int. Cl. G02B 7/02

(52) U.S. Cl. CPC G02B 7/028; G02B 7/021

(57) ABSTRACT

A lens unit includes a first lens barrel accommodating a first lens, a second lens barrel accommodating a second lens, a spacer whose linear expansion coefficient is higher than those of the first lens barrel and the second lens barrel, and an elastic member. The first lens barrel has a first stepped part and the second lens barrel has a second stepped part, and they face each other in an optical axis direction. The spacer is disposed between the first stepped part and the second stepped part and the elastic member is disposed in an elastically deformed state on an opposite side to the spacer in the optical axis direction. When temperature becomes higher, the spacer thermally expands in the optical axis direction and pushes the second lens barrel to crush the elastic member and thus, deviation of a focus position due to heat is suppressed.

### CROSS REFERENCE TO RELATED APPLICATION

The present invention claims priority under 35 U.S.C. § 119 to Japanese Application No. 2024-088766 filed May 31, 2024, the entire content of which is incorporated herein by reference.

### TECHNICAL FIELD

At least an embodiment of the present invention may relate to a lens unit.

### BACKGROUND

A lens unit used in an in-vehicle camera and the like is described in Japanese Patent Laid-Open No. 2024-000240 (Patent Literature 1). The lens unit described in Patent Literature 1 includes a first lens barrel member holding a first lens and a second lens barrel member holding a lens group including a second lens which is located on an image side with respect to the first lens on an inner peripheral side of the first lens barrel member. An imaging element is disposed on an image side of the lens unit described in Patent Literature 1.

Further, a lens unit which is structured to suppress deviation of a focus position with respect to an imaging element when affected by heat is described in Japanese Patent Laid-Open No. 2003-262777 (Patent Literature 2). The lens unit described in Patent Literature 2 is structured so that respective lenses are individually held by respective different lens frames. A plurality of lens frames are formed of materials whose linear expansion coefficients are respectively different from each other. An imaging device described in Patent Literature 2 is structured so that a plurality of the lenses are individually held and the linear expansion coefficients of respective lens frames are adjusted and thereby, deviation of a focus position due to temperature change is suppressed small.

In the lens unit described in Patent Literature 1, when temperature of the lens unit becomes higher due to influence of heat, a focus distance of the lens unit may become longer or become shorter depending on a lens structure used in the lens unit. Therefore, even when the technique described in Patent Literature 2 is applied to the lens unit in Patent Literature 1, it is difficult to select materials of the lens frames depending on a lens structure and thus, deviation of a focus position with respect to an imaging element cannot be appropriately suppressed.

### SUMMARY

In view of the problem described above, at least an embodiment of the present invention may advantageously provide a lens unit which is capable of appropriately suppressing deviation of a focus position with respect to an imaging element when the lens unit is affected by heat.

According to at least an embodiment of the present invention, there may be provided a lens unit including a first unit having a first lens and a first lens barrel member accommodating the first lens, a second unit having a second lens disposed on an image side with respect to the first lens and a second lens barrel member which accommodates the second lens and is held on an inner peripheral side of the first lens barrel member, a spacer in a tube shape which is disposed on an inner side of the first lens barrel member and is made of material whose linear expansion coefficient is higher than those of the first lens barrel member and the second lens barrel member, and an elastic member in a ring shape which is disposed on an inner side of the first lens barrel member. The first lens barrel member is provided with a first stepped part in a ring shape which is protruded from its inner peripheral side to an inner side in a radial direction, the second lens barrel member is provided with a second stepped part in a ring shape which is protruded from its outer peripheral side to an outer side in the radial direction, the first stepped part is provided with a first face part facing one of an object side and an image side, and the second stepped part is provided with a second face part which faces the other of the object side and the image side and faces the first face part. The spacer is disposed between the first stepped part and the second stepped part and contacts with the first face part and the second face part, and the elastic member is disposed on an opposite side to a side where the spacer is disposed with respect to the second stepped part in an optical axis direction along an optical axis of the first lens and contacts with the first unit and the second unit in an elastically deformed state in the optical axis direction. When temperature of the first lens barrel member, the second lens barrel member and the spacer becomes higher, the spacer thermally expands in the optical axis direction and pushes the second lens barrel member to a side where the elastic member is disposed, and the second lens barrel member is moved to the side where the elastic member is disposed by crushing the elastic member in the optical axis direction and, when the temperature of the first lens barrel member, the second lens barrel member and the spacer becomes lower, the spacer thermally shrinks in the optical axis direction and thereby, the elastic member is restored in the optical axis direction, and the second lens barrel member is moved to the side where the spacer is disposed by the elastic member restored in the optical axis direction.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is an outside appearance perspective view showing a lens unit in accordance with a first embodiment of the present invention.

FIG. 2 is a sectional view showing the lens unit in FIG. 1.

FIG. 3 is an exploded perspective view showing the lens unit in FIG. 1.

FIG. 4 is a sectional view showing a lens unit in accordance with a second embodiment of the present invention.

FIG. 5 is a sectional view showing a lens unit in accordance with a third embodiment of the present invention.

FIG. 6 is a perspective view showing a spacer in accordance with the third embodiment of the present invention.

FIG. 7 is a sectional view showing a lens unit in accordance with a fourth embodiment of the present invention.

FIG. 8 is a sectional view showing a lens unit in accordance with a fifth embodiment of the present invention.

FIG. 9 is a sectional view showing a lens unit in accordance with a sixth embodiment of the present invention.

FIG. 10 is a sectional view showing a lens unit in accordance with a modified embodiment of the present invention.

### DETAILED DESCRIPTION

Embodiments of the lens unit to which the present invention is applied will be described below with reference to the accompanying drawings.

### First Embodiment

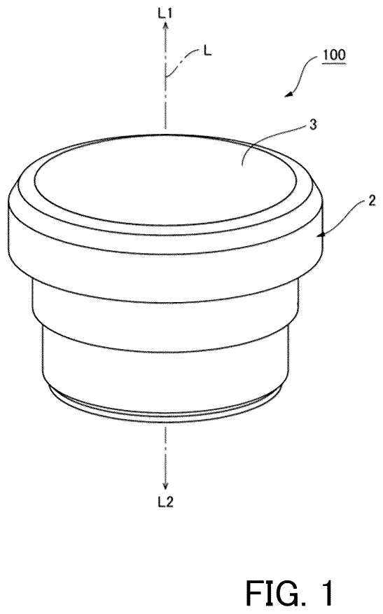

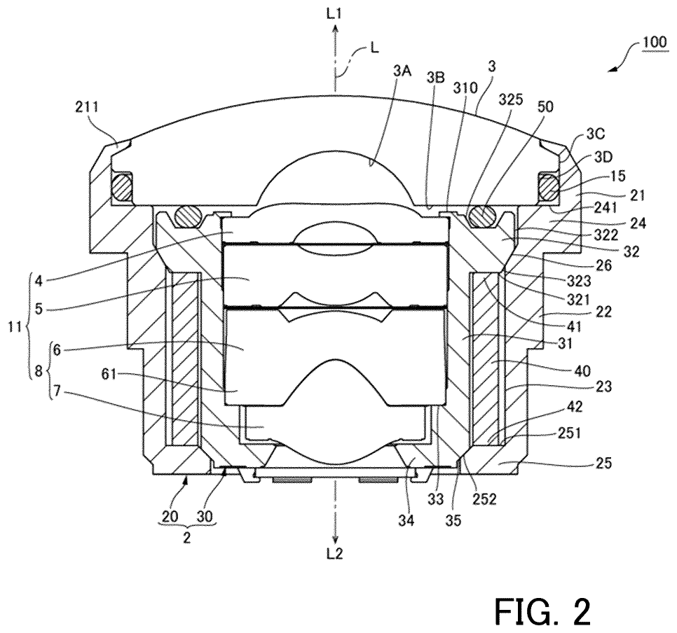

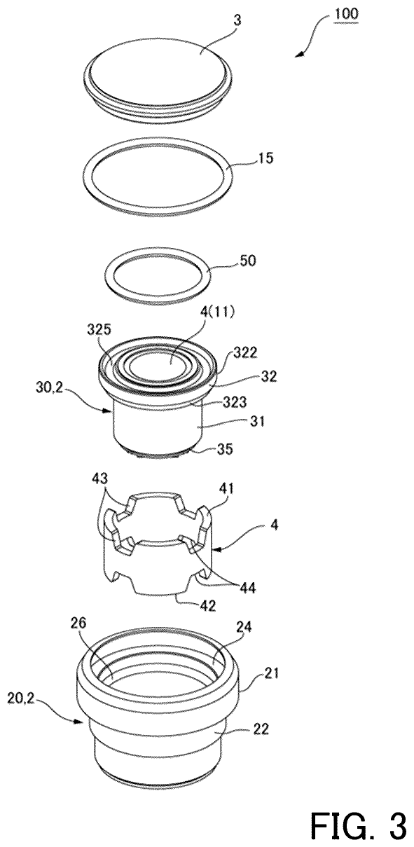

FIG. 1 is an outside appearance perspective view showing a lens unit in accordance with a first embodiment of the present invention. FIG. 2 is a sectional view showing the lens unit in FIG. 1. FIG. 3 is an exploded perspective view showing the lens unit. A lens unit 100 in this embodiment is used in an imaging device which is mounted on an automobile or a monitoring camera.

### Entire Structure

As shown in FIG. 1, the lens unit 100 includes a first lens 3 and a lens barrel 2. As shown in FIG. 2, the lens unit 100 includes a lens group 11 consisting of a plurality of lenses which are held by the lens barrel 2 on an image side “L2” with respect to the first lens 3 in an optical axis direction along an optical axis “L” of the first lens 3. The lens unit 100 includes a spacer 40 in a tube shape which is disposed on an inner side of the lens barrel 2 and an elastic member 50 in a ring shape which is disposed on an inner side of the lens barrel 2. The lens group 11 includes a second lens 4, third lens 5, fourth lens 6 and fifth lens 7 from an object side “L1” toward an image side “L2” in the optical axis direction. Each of the lenses 4 through 7 structuring the lens group 11 has a smaller outer diameter dimension than the first lens 3.

### Lens

The first lens 3 is made of resin or glass. As shown in FIG. 2, the first lens 3 is a meniscus lens having a convex shape on the object side “L1”. The first lens 3 has the largest power among the lenses used in the lens unit 100. The first lens 3 is provided with an end face 3B in a ring shape which is enlarged in a direction perpendicular to the optical axis “L” on an outer peripheral side with respect to a lens surface 3A on the image side “L2”. An outer peripheral face on the image side “L2” of the first lens 3 is provided with a first outer peripheral face 3C, which is a large diameter part, and a second outer peripheral face 3D which is a small diameter part located on the image side “L2” with respect to the large diameter part and has a smaller diameter than the large diameter part. An elastic member 15 in a ring shape is disposed on the second outer peripheral face 3D. The elastic member 15 is an O-ring.

The second lens 4 is made of resin. The second lens 4 is a meniscus lens having a convex shape on the object side “L1”. The third lens 5 is made of resin or glass. In this embodiment, the third lens 5 is made of resin. The third lens 5 is a meniscus lens having a convex shape on the image side “L2”. The fourth lens 6 and the fifth lens 7 are made of resin. The fourth lens 6 and the fifth lens 7 are joined to each other to structure one cemented lens 8.

### Lens Barrel

As shown in FIGS. 2 and 3, the lens barrel 2 includes a first lens barrel member 20 which holds the first lens 3 and a second lens barrel member 30 which holds the lens group 11. The second lens barrel member 30 is held on an inner peripheral side of the first lens barrel member 20. In this embodiment, the first lens 3 and the first lens barrel member 20 correspond to a first unit in the present invention, and the second lens 4 and the second lens barrel member 30 correspond to a second unit in the present invention.

The first lens barrel member 20 is made of crystalline resin having a light absorption property. The second lens barrel member 30 is made of amorphous resin having a light absorption property. In this embodiment, the first lens barrel member 20 is made of polyamide-based resin. The second lens barrel member 30 is made of polycarbonate.

### First Lens Barrel Member

As shown in FIGS. 2 and 3, the first lens barrel member 20 is provided with a first tube part 21 which holds the first lens 3 from an outer peripheral side, a second tube part 22 which holds the second lens barrel member 30 from an outer peripheral side, a stepped part 24 in a ring shape formed at an end part on the object side “L1” of the second tube part 22, and a stepped part (first stepped part) 25 in a ring shape which is protruded from an end part on the image side “L2” of the second tube part 22 to an inner peripheral side.

The first tube part 21 is provided with a contact part 211 which is bent to an inner peripheral side at an end part on the object side “L1” and contacts with the first lens 3 from the object side “L1”. The stepped part 24 is provided with an end face 241 which faces the object side “L1”. The end face 241 contacts with the end face 3B of the first lens 3 and positions the first lens 3 in the optical axis direction. The stepped part 25 is provided with a first face part 251 which faces the object side “L1” and a first inclined face 252 which is inclined from an inner peripheral end of the first face 251 toward the image side “L2” and from an outer side in the radial direction to an inner side in the radial direction. The second tube part 22 is provided with a first contact face 26 which is inclined toward the object side “L1” on an inner peripheral face 23 in an end portion on the object side “L1” from an inner side in the radial direction to an outer side in the radial direction.

### Second Lens Barrel Member

As shown in FIGS. 2 and 3, the second lens barrel member 30 is inserted into an inner side of the first lens barrel member 20 from the object side “L1”. The second lens barrel member 30 is provided with a main body tube 31 which holds the lens group 11, a flange part (second stepped part) 32 in a ring shape which is protruded from an end part on the object side “L1” of the main body tube 31 to an outer side in the radial direction, a stepped part 33 in a ring shape which is protruded from an inner peripheral side of the main body tube 31 to an inner side in the radial direction, a ring-shaped plate part 34 which is protruded from an end part on the image side “L2” of the main body tube 31 to an inner side in the radial direction, and a second contact face 35 provided on an outer peripheral face of an end part on the image side “L2” of the main body tube 31. The main body tube 31 is provided with a contact part 310, which is bent to an inner peripheral side and contacts with the second lens 4 from the object side “L1”, at an end part on the object side “L1”.

The flange part 32 is provided with a second face part 321 facing the image side “L2”, a second inclined face 323, which is inclined from an outer peripheral end of the second face part 321 toward the object side “L1” and from an inner side in the radial direction to an outer side in the radial direction, and a groove part 325 formed on a face facing the object side “L1”. The second face part 321 faces the first face part 251 in the optical axis direction. The second inclined face 323 contacts with the first contact face 26. In this embodiment, the first contact face 26 is an inclined face corresponding to the second inclined face 323. The elastic member 50 is disposed in the groove part 325.

The stepped part 33 contacts with a flange part 61 of the fourth lens 6 from the image side “L2” and supports the lens group 11 from the image side “L2”. An end edge on an inner peripheral side of the ring-shaped plate part 34 is formed in a circular opening shape. An imaging element not shown is fixed to the ring-shaped plate part 34 on its image side “L2”. The second contact face 35 is an inclined face corresponding to the first inclined face 252 and contacts with the first inclined face 252.

When the second lens barrel member 30 is disposed on an inner side of the first lens barrel member 20, the first inclined face 252 and the second contact face 35 contact with each other and, in addition, the second inclined face 323 and the first contact face 26 contact with each other and thereby, the second lens barrel member 30 is positioned in the radial direction with respect to the first lens barrel member 20.

### Spacer

The spacer 40 is made of material whose linear expansion coefficient is higher than those of the first lens barrel member 20 and the second lens barrel member 30. For example, the spacer 40 is made of polyamide-based resin or polyacetal-based resin. As a result, when temperature of the lens unit 100 becomes higher, the spacer 40 thermally expands larger than the first lens barrel member 20 and second lens barrel member 30.

As shown in FIGS. 2 and 3, the spacer 40 is formed in a tube shape. A first end part 41 on the object side “L1” of the spacer 40 is formed with cut-out parts 43 which are provided at equal intervals in a circumferential direction. In this embodiment, the cut-out part 43 is formed at four positions. A second end part 42 on the image side “L2” of the spacer 40 is formed with cut-out parts 44 which are provided at equal intervals in the circumferential direction. In this embodiment, the cut-out part 44 is formed at four positions. A gate trace is formed on the first end part 41 or the second end part 42 of the spacer 40. In this embodiment, the gate trace is formed on the first end part 41 or the second end part 42, and the spacer 40 is formed with the cut-out parts 43 and the cut-out parts 44. Therefore, the linear expansion coefficient in a longitudinal direction which is the optical axis direction of the spacer 40 is larger than the linear expansion coefficient in a lateral direction which is perpendicular to the optical axis direction of the spacer 40.

The spacer 40 is disposed on an inner side with respect to the first lens barrel member 20. More specifically, the spacer 40 is disposed between the stepped part 25 and the flange part 32 and contacts with the first face part 251 and the second face part 321. In other words, the spacer 40 determines a distance in the optical axis direction between the first lens barrel member 20 and the second lens barrel member 30.

### Elastic Member

As shown in FIGS. 2 and 3, the elastic member 50 is disposed on the groove part 325 on the object side “L1” of the flange part 32. In other words, the elastic member 50 is disposed on the object side “L1” of the flange part 32 in the optical axis direction which is an opposite side to the side where the spacer 40 is disposed. The elastic member 50 and the spacer 40 are overlapped with each other in the optical axis direction when viewed in the optical axis direction. The elastic member 50 is formed in a ring shape. In this embodiment, the elastic member 50 is an O-ring. The elastic member 50 contacts with the end face 3B of the first lens 3 and the groove part 325 in an elastically deformed state in the optical axis direction.

In the structure described above, when temperature of the lens unit 100 becomes higher due to influence of external heat or heat of the imaging element, the first lens barrel member 20 and the second lens barrel member 30 thermally expand and thereby, a focus position of the lens unit 100 is shifted with respect to the imaging element. In this embodiment, when temperature of the lens unit 100 becomes higher, a focus distance of the lens unit 100 becomes longer and the focus position is shifted to the image side “L2”.

On the other hand, when temperature of the lens unit 100 becomes higher, the spacer 40 thermally expands in the optical axis direction and pushes the second lens barrel member 30 to the object side “L1” where the elastic member 50 is disposed. In this case, the elastic member 50 is crushed in the optical axis direction and the second lens barrel member 30 is moved to the object side “L1” where the elastic member 50 is disposed. As a result, an inter-lens distance between the first lens 3 and the lens group 11 including the second lens 4 is reduced and the focus distance of the lens unit 100 becomes shorter.

Further, when the temperature of the lens unit 100 becomes lower because influence of external heat applied to the lens unit 100 and heat of the imaging element becomes smaller, the elastic member 50 is restored in the optical axis direction through thermal shrinkage of the spacer 40 in the optical axis direction. In this case, the second lens barrel member 30 is moved to the image side “L2” by the elastic member 50 restored in the optical axis direction. Accordingly, the inter-lens distance between the first lens 3 and the lens group 11 including the second lens 4 becomes longer and the focus distance of the lens unit 100 is increased. As a result, even in a case that the focus distance of the lens unit 100 becomes longer as the temperature of the lens unit 100 becomes higher, the lens unit 100 is capable of appropriately suppressing deviation of the focus position with respect to the imaging element.

### Operations and Effects

The lens unit 100 in this embodiment includes the first lens barrel member 20 accommodating the first lens 3, the second lens barrel member 30 which accommodates the second lens 4 disposed on the image side “L2” with respect to the first lens 3 and is held on an inner peripheral side of the first lens barrel member 20, the spacer 40 in a tube shape which is disposed on an inner side of the first lens barrel member 20 and is made of material whose linear expansion coefficient is higher than those of the first lens barrel member 20 and the second lens barrel member 30, and the elastic member 50 in a ring shape which is disposed on an inner side of the first lens barrel member 20. The first lens barrel member 20 is provided with the stepped part 25 in a ring shape which is protruded from its inner peripheral side to an inner side in a radial direction. The second lens barrel member 30 is provided with the flange part 32 in a ring shape which is protruded from its outer peripheral side to an outer side in the radial direction. The stepped part 25 is provided with the first face part 251 facing the object side “L1”. The flange part 32 is provided with the second face part 321 which faces the image side “L2” and faces the first face part 251. The spacer 40 is disposed between the stepped part 25 and the flange part 32 and contacts with the first face part 251 and the second face part 321. The elastic member 50 is disposed on the object side “L1” of the flange part 32 in the optical axis direction which is opposite to a side where the spacer 40 is disposed, and the elastic member 50 contacts with the first lens 3 and the second lens barrel member 30 in a state elastically deformed in the optical axis direction. When temperature of the lens unit 100 becomes higher, the spacer 40 thermally expands in the optical axis direction and pushes the second lens barrel member 30 to the object side “L1” where the elastic member 50 is disposed, and the second lens barrel member 30 is moved to the object side “L1” where the elastic member 50 is disposed by crushing the elastic member 50 in the optical axis direction. When the temperature of the lens unit 100 becomes lower, the elastic member 50 is restored in the optical axis direction through thermal shrinkage of the spacer 40 in the optical axis direction, and the second lens barrel member 30 is moved to the image side “L2” by the elastic member 50 restored in the optical axis direction.

According to the lens unit 100 in this embodiment, when temperature of the lens unit 100 becomes higher, the second lens barrel member 30 is moved to the object side “L1” and thus, an inter-lens distance between the first lens 3 and the lens group 11 including the second lens 4 is reduced and a focus distance of the lens unit 100 becomes shorter. Further, when the temperature of the lens unit 100 becomes lower, the second lens barrel member 30 is moved to the image side “L2” and thus, the inter-lens distance between the first lens 3 and the lens group 11 including the second lens 4 becomes longer and the focus distance of the lens unit 100 is increased. As a result, the lens unit 100 is capable of appropriately suppressing deviation of the focus position with respect to the imaging element depending on temperature change of the lens unit 100.

The stepped part 25 is provided in a portion on the image side “L2” of the first lens barrel member 20. The flange part 32 is provided in a portion on the object side “L1” of the second lens barrel member 30. The second lens barrel member 30 is inserted into an inner side of the first lens barrel member 20 from the object side “L1”. As a result, a length in the optical axis direction of the spacer 40 disposed between the stepped part 25 and the flange part 32 can be increased and thus, an amount of variation in the optical axis direction of the spacer can be increased depending on temperature change.

The stepped part 25 is provided with the first inclined face 252 which is inclined from an inner peripheral end of the first face part 251 toward the image side “L2”, i.e., from an outer side in the radial direction to an inner side in the radial direction. The flange part 32 is provided with the second inclined face 323 which is inclined from an outer peripheral end of the second face part 321 toward the object side “L1”, i.e., from an inner side in the radial direction to an outer side in the radial direction. The first lens barrel member 20 is provided on its inner peripheral face with the first contact face 26 which is an inclined face corresponding to the second inclined face 323 and contacts with the second inclined face 323. The second lens barrel member 30 is provided on its outer peripheral face with the second contact face 35 which is an inclined face corresponding to the first inclined face 252 and contacts with the first inclined face 252. When the second lens barrel member 30 is disposed on an inner side of the first lens barrel member 20, the first inclined face 252 and the second contact face 35 contact with each other and, in addition, the second inclined face 323 and the first contact face 26 contact with each other and thereby, the second lens barrel member 30 is positioned in the radial direction with respect to the first lens barrel member 20. In this structure, when temperature of the lens unit 100 becomes higher, an inner peripheral side of the first lens barrel member 20 expands to an inner side in the radial direction and an outer peripheral side of the second lens barrel member 30 expands to an outer side in the radial direction. Therefore, the first inclined face 252 and the second contact face 35 come closer to each other in the radial direction, and the second inclined face 323 and the first contact face 26 come closer to each other in the radial direction. However, in this case, when the second lens barrel member 30 is moved to the object side “L1”, the first inclined face 252 and the second contact face 35, and the second inclined face 323 and the first contact face 26 are respectively separated from each other in the radial direction. Therefore, the first inclined face 252 and the second contact face 35, and the second inclined face 323 and the first contact face 26 are respectively kept in an appropriate positional relationship. As a result, even in a case that temperature of the lens unit 100 becomes higher, the second lens barrel member 30 is appropriately positioned with respect to the first lens barrel member 20 in the radial direction.

The spacer 40 and the elastic member 50 are overlapped with each other in the optical axis direction when viewed in the optical axis direction. As a result, the spacer 40 and the elastic member 50 are capable of smoothly moving the second lens barrel member 30 in the optical axis direction.

### Second Embodiment

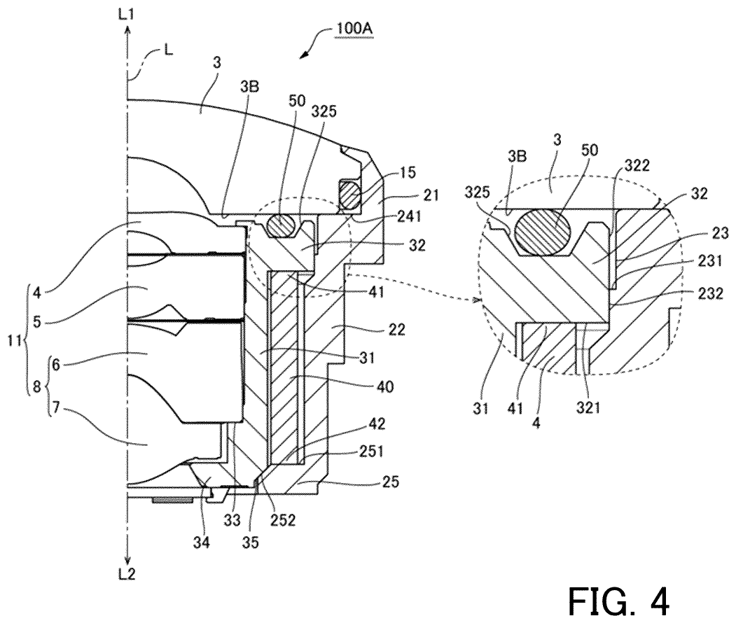

FIG. 4 is a sectional view showing a lens unit 100A in accordance with a second embodiment of the present invention. As shown in FIG. 4, in the lens unit 100A in the second embodiment, a shape of the flange part 32 of the second lens barrel member 30 is different from the lens unit 100 in the first embodiment. Therefore, in the second embodiment, the same reference symbols are used for the same structures as the first embodiment, and their explanations may be omitted.

The flange part 32 is provided with a second face part 321 facing the image side “L2”, an outer peripheral face (first outer peripheral face) 322 which is linearly extended to the object side “L1” from an outer peripheral end of the second face part 321, and a groove part 325 formed on a face facing the object side “L1”.

The first tube part 21 is provided with a protruding part 231 in a ring shape which is protruded from the inner peripheral face 23 in an end portion on the object side “L1” to an inner peripheral side. The flange part 32 is lightly press-fitted to an inner side of the first lens barrel member 20. In this case, an outer peripheral face 322 of the flange part 32 contacts with an inner peripheral face (first contact face) 232 of the protruding part 231 in a radial direction. Further, the first inclined face 252 contacts with the second contact face 35. As a result, the second lens barrel member 30 is positioned with respect to the first lens barrel member 20 in the radial direction.

### Operations and Effects

According to the lens unit 100A in this embodiment, the second lens barrel member 30 is lightly press-fitted to an inner side of the first lens barrel member 20. Therefore, even in a case that the second lens barrel member 30 is positioned with respect to the first lens barrel member 20 in a radial direction, the second lens barrel member 30 is capable of moving in the optical axis direction on an inner side of the first lens barrel member 20 even if a force which is applied to the second lens barrel member 30 in the optical axis direction is small.

The lens unit 100A in this embodiment is capable of attaining similar effects to the lens unit 100 in the first embodiment in portions having the same structures as the lens unit 100 in the first embodiment.

### Third Embodiment

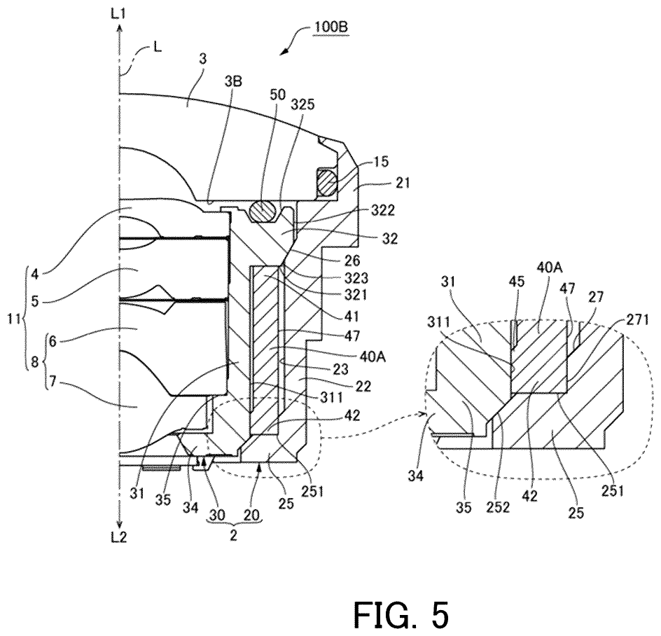

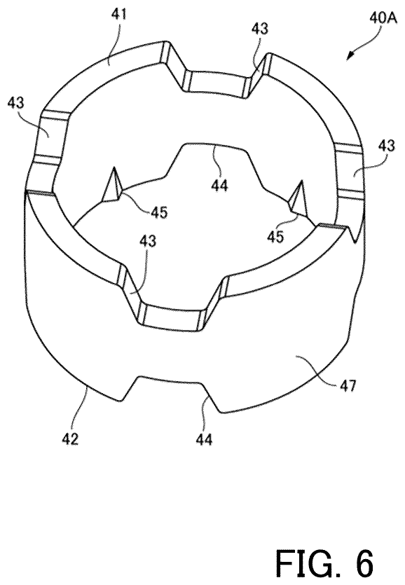

FIG. 5 is a sectional view showing a lens unit 100B in accordance with a third embodiment of the present invention. FIG. 6 is a perspective view showing a spacer 40A in accordance with the third embodiment of the present invention. As shown in FIGS. 5 and 6, in the lens unit 100B in the third embodiment, a shape of a spacer 40A is different from that of the lens unit 100 in the first embodiment. Therefore, in the third embodiment, the same reference symbols are used for the same structures as the first embodiment, and their explanations may be omitted.

As shown in FIG. 5, the first lens barrel member 20 is provided with a protruding part 27 in a ring shape which is protruded to an inner peripheral side from the inner peripheral face 23 of an end portion on the image side “L2” of the second tube part 22.

As shown in FIG. 5, the spacer 40A is press-fitted to an inner side of the second tube part 22 of the first lens barrel member 20. In this case, an outer peripheral face 47 of an end portion on the image side “L2” of the spacer 40A contacts with an inner peripheral face 271 of the protruding part 27 in the radial direction.

As shown in FIGS. 5 and 6, the spacer 40A is provided on an inner peripheral face of an end portion on the image side “L2” with a plurality of ribs 45 which are protruded to an inner side in the radial direction and are separately disposed in a circumferential direction. In this embodiment, the ribs 45 are provided at four positions.

As shown in FIG. 5, the second lens barrel member 30 is lightly press-fitted to an inner side of the spacer 40A. In this case, an outer peripheral face 311 of an end portion on the image side “L2” of the main body tube 31 contacts with the ribs 45 in the radial direction. Further, when viewed in a direction perpendicular to the optical axis direction, the protruding part 27 and the ribs 45 are disposed at a position coincided in the radial direction. As a result, the second lens barrel member 30 is positioned with respect to the first lens barrel member 20 in the radial direction through the spacer 40A.

In this embodiment, when viewed in a direction perpendicular to the optical axis direction, the fifth lens 7 located on an inner side of the main body tube 31 and coincided with the protruding part 27 and the ribs 45 in the radial direction does not contact with an inner peripheral face of the main body tube 31. As a result, even in a case that the second lens barrel member 30 is positioned with respect to the first lens barrel member 20 in the radial direction through the spacer 40A, the fifth lens 7 does not receive pressure in the radial direction and thus, deterioration of lens performance is suppressed.

### Operations and Effects

According to the lens unit 100B in this embodiment, the second lens barrel member 30 is lightly press-fitted to an inner side of the spacer 40A. Therefore, even in a case that the second lens barrel member 30 is positioned with respect to the first lens barrel member 20 in the radial direction through the spacer 40A, the second lens barrel member 30 is capable of moving in the optical axis direction on an inner side of the spacer 40A even if a force which is applied to the second lens barrel member 30 in the optical axis direction is small.

The lens unit 100B in the third embodiment is capable of attaining similar effects to the lens unit 100 in the first embodiment in portions having the same structures as the lens unit 100 in the first embodiment.

### Fourth Embodiment

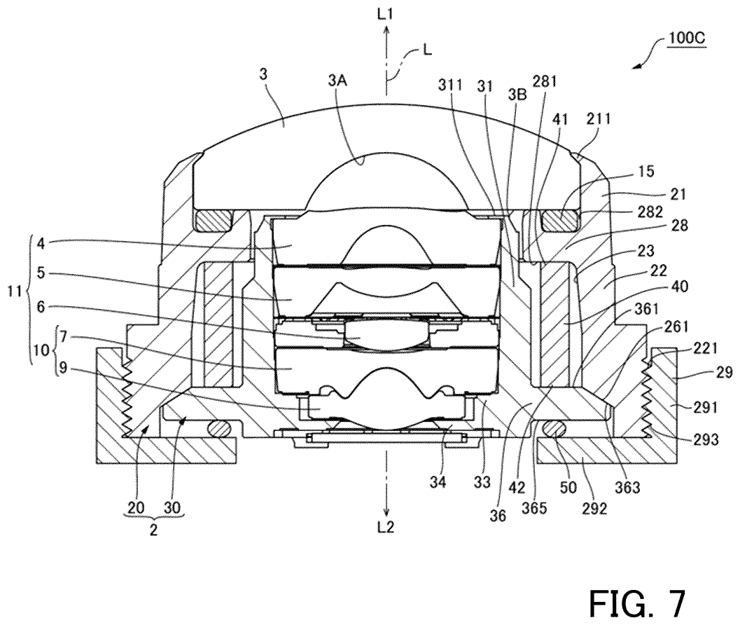

FIG. 7 is a sectional view showing a lens unit 100C in accordance with a fourth embodiment of the present invention. As shown in FIG. 7, in the lens unit 100C in the fourth embodiment, a shape of the second lens barrel member 30 is different from that of the lens unit 100 in the first embodiment. Therefore, in the fourth embodiment, the same reference symbols are used for the same structures as the first embodiment, and their explanations may be omitted.

As shown in FIG. 7, the lens unit 100C includes the first lens 3 and the lens barrel 2. The lens unit 100C includes the lens group 11 consisting of a plurality of lenses, which are held by the lens barrel 2, on the image side “L2” with respect to the first lens 3 in an optical axis direction along an optical axis “L” of the first lens 3. The lens unit 100C includes a spacer 40 in a tube shape which is disposed on an inner side of the lens barrel 2 and an elastic member 50 in a ring shape which is disposed on an inner side of the lens barrel 2. The lens group 11 includes a second lens 4, third lens 5, fourth lens 6, fifth lens 7 and sixth lens 9 from an object side “L1” toward the image side “L2” in the optical axis direction.

### Lens

The first lens 3 is made of resin or glass. As shown in FIG. 7, the first lens 3 is a meniscus lens having a convex shape on the object side “L1”. The first lens 3 is provided with an end face 3B in a ring shape which is enlarged in a direction perpendicular to the optical axis “L” on an outer peripheral side of a lens surface 3A on the image side “L2”. An elastic member 15 in a ring shape is disposed on the end face 3B. The elastic member 15 is an O-ring. The second lens 4 through the sixth lens 9 are made of resin or glass. In this embodiment, the second lens 4, third lens 5, fifth lens 7 and sixth lens 9 are made of resin, and the fourth lens 6 is made of glass. The fifth lens 7 and the sixth lens 9 are joined to each other to structure one cemented lens 10.

### Lens Barrel

As shown in FIG. 7, the lens barrel 2 includes a first lens barrel member 20 which holds the first lens 3 and a second lens barrel member 30 which holds the lens group 11. The second lens barrel member 30 is held on an inner peripheral side of the first lens barrel member 20. In this embodiment, the first lens 3 and the first lens barrel member 20 correspond to a first unit in the present invention, and the second lens 4 and the second lens barrel member 30 correspond to a second unit in the present invention.

### First Lens Barrel Member

As shown in FIG. 7, The first lens barrel member 20 is provided with a first tube part 21 which holds the first lens 3 from an outer peripheral side, a second tube part 22 which holds the second lens barrel member 30 from an outer peripheral side, a stepped part 28 in a ring shape which is provided in an end part on the object side “L1” of the second tube part 22, and a fixing member 29 for fixing the second lens barrel member 30 to the first lens barrel member 20.

The first tube part 21 is provided with a contact part 211 which is bent to an inner peripheral side at an end part on the object side “L1” and contacts with the first lens 3 from the object side “L1”. The stepped part (first stepped part) 28 is provided with a first face part 281 facing the image side “L2” and a groove part 282 formed on a face facing the object side “L1”. The elastic member 15 is disposed in the groove part 282. The elastic member 15 is an O-ring. The elastic member 15 contacts with the end face 3B of the first lens 3 and the groove part 282 in an elastically deformed state in the optical axis direction.

The second tube part 22 is provided on its inner peripheral face 23 with a first contact face 261 which is inclined toward the image side “L2” from an inner side in the radial direction to an outer side in the radial direction. A male screw part 221 is formed on an outer peripheral face in an end portion on the image side “L2” of the second tube part 22. The fixing member 29 is provided with a cylindrical part 291 which surrounds an outer peripheral side of the second tube part 22 and a ring-shaped plate part 292 which is protruded from an end part on the image side “L2” of the cylindrical part 291 to an inner side in the radial direction. A female screw part 293 is formed on an inner peripheral face of the cylindrical part 291. The male screw part 221 is screwed into the female screw part 293 and thereby, the fixing member 29 is fixed to an end part on the image side “L2” of the second tube part 22.

### Second Lens Barrel Member

As shown in FIG. 7, the second lens barrel member 30 is inserted into an inner side of the first lens barrel member 20 from the image side “L2”. The second lens barrel member 30 is provided with a main body tube 31 which holds the lens group 11, a flange part (second stepped part) 36 which is protruded from an end part on the image side “L2” of the main body tube 31 to an outer side in the radial direction, a stepped part 33 in a ring shape which is protruded from an inner peripheral side of the main body tube 31 to an inner side in the radial direction, and a ring-shaped plate part 34 which is protruded from an end part on the image side “L2” of the main body tube 31 to an inner side in the radial direction. The main body tube 31 is provided with a contact part 311 which is bent to an inner peripheral side at an end part on the object side “L1” and contacts with the second lens 4 from the object side “L1”.

The flange part 36 is provided with a second face part 361 facing the object side “L1”, a second inclined face 363 which is inclined from an outer peripheral end of the second face part 361 toward the image side “L2”, i.e., from an inner side in the radial direction to an outer side in the radial direction, and an end face 365 which faces the image side “L2”. The second face part 321 faces the first face part 281 in the optical axis direction. In this embodiment, the first contact face 261 is an inclined face corresponding to the second inclined face 363 and contacts with the second inclined face 363. When the second lens barrel member 30 is disposed on an inner side of the first lens barrel member 20, the second lens barrel member 30 is positioned with respect to the first lens barrel member 20 in the radial direction by contacting the second inclined face 363 with the first contact face 261.

As shown in FIG. 7, a spacer 40 is disposed on an inner side of the first lens barrel member 20. More specifically, the spacer 40 is disposed between the stepped part 28 and the flange part 36 and contacts with the first face part 281 and the second face part 361. In other words, the spacer 40 determines a distance in the optical axis direction between the first lens barrel member 20 and the second lens barrel member 30.

### Elastic Member

As shown in FIG. 7, the elastic member 50 is disposed on the end face 365 on the image side “L2” of the flange part 36. In other words, the elastic member 50 is disposed on the image side “L2”, which is an opposite side to a side where the spacer 40 is disposed, with respect to the flange part 36 in the optical axis direction. The elastic member 50 and the spacer 40 are overlapped with each other in the optical axis direction when viewed in the optical axis direction. The elastic member 50 is formed in a ring shape. In this embodiment, the elastic member 50 is an O-ring. The elastic member 50 contacts with the end face 365 of the flange part 36 and the ring-shaped plate part 292 of the fixing member 29 in an elastically deformed state in the optical axis direction.

In this embodiment, in the lens unit 100C, the fourth lens 6 structuring the lens group 11 is made of glass and thus, when temperature of the lens unit 100C becomes higher, a focus distance of the lens unit 100C is reduced and its focus position is shifted to the object side “L1”. On the other hand, when temperature of the lens unit 100C becomes higher, the spacer 40 thermally expands in the optical axis direction and pushes the second lens barrel member 30 to the image side “L2” where the elastic member 50 is disposed. In this case, the second lens barrel member 30 is moved to the image side “L2” where the elastic member 50 is disposed by crushing the elastic member 50 in the optical axis direction. As a result, an inter-lens distance between the first lens 3 and the lens group 11 including the second lens 4 becomes longer, and a focus distance of the lens unit 100 is increased.

Further, when temperature of the lens unit 100C becomes lower, the elastic member 50 is restored in the optical axis direction through thermal shrinkage of the spacer 40 in the optical axis direction. In this case, the second lens barrel member 30 is moved to the object side “L1” by the elastic member 50 restored in the optical axis direction. Accordingly, an inter-lens distance between the first lens 3 and the lens group 11 including the second lens 4 becomes shorter, and a focus distance of the lens unit 100 is decreased. As a result, even if a focus distance of the lens unit 100C becomes shorter as temperature of the lens unit 100C becomes higher, the lens unit 100C is capable of appropriately suppressing deviation of a focus position with respect to the imaging element.

### Operations and Effects

The lens unit 100C in this embodiment is capable of attaining similar effects to the lens unit 100 in the first embodiment.

### Fifth Embodiment

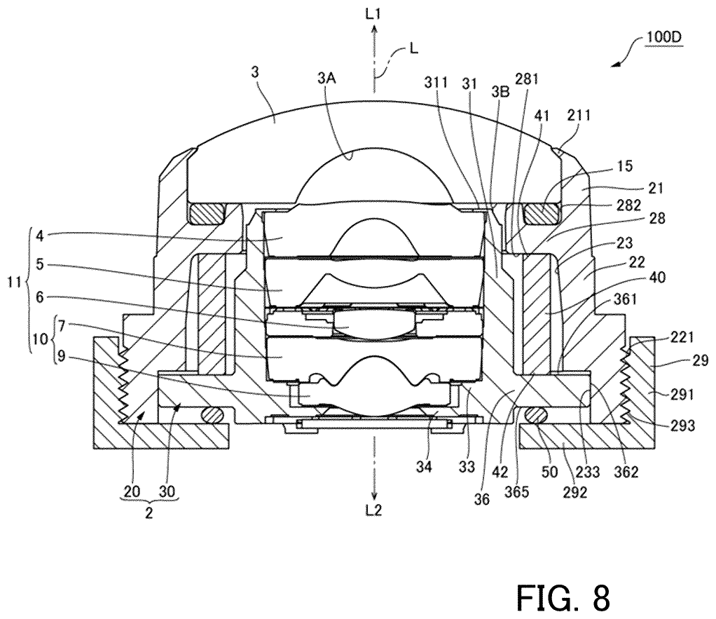

FIG. 8 is a sectional view showing a lens unit 100D in accordance with a fifth embodiment of the present invention. As shown in FIG. 8, in the lens unit 100D in the fifth embodiment, a shape of the flange part 36 of the second lens barrel member 30 is different from that of the lens unit 100C in the fourth embodiment. Therefore, in the fifth embodiment, the same reference symbols are used for the same structures as the fourth embodiment, and their explanations may be omitted.

As shown in FIG. 8, the second lens barrel member 30 is inserted into an inner side of the first lens barrel member 20 from the image side “L2”. The second lens barrel member 30 is provided with the main body tube 31 which holds the lens group 11, the flange part (second stepped part) 36 protruding from an end part on the image side “L2” of the main body tube 31 to an outer side in the radial direction, the stepped part 33 in a ring shape protruding from an inner peripheral side of the main body tube 31 to an inner side in the radial direction, and the ring-shaped plate part 34 protruding from an end part on the image side “L2” of the main body tube 31 to an inner side in the radial direction.

The flange part 36 is provided with a second face part 361 facing the object side “L1”, an outer peripheral face (first outer peripheral face) 362 which is linearly extended to the image side “L2” from an outer peripheral end of the second face part 361, and an end face 365 facing the image side “L2”. The second face part 361 faces the first face part 281 in the optical axis direction. The flange part 36 is lightly press-fitted to an inner side of the first lens barrel member 20. In this case, the outer peripheral face 362 of the flange part 36 contacts with the inner peripheral face (first contact face) 233 in the radial direction. As a result, the second lens barrel member 30 is positioned in the radial direction with respect to the first lens barrel member 20.

### Operations and Effects

According to the lens unit 100D in this embodiment, the second lens barrel member 30 is lightly press-fitted to an inner side of the first lens barrel member 20. Therefore, even in a case that the second lens barrel member 30 is positioned with respect to the first lens barrel member 20 in the radial direction, the second lens barrel member 30 is capable of moving in the optical axis direction on an inner side of the first lens barrel member 20 even if a force applied to the second lens barrel member 30 in the optical axis direction is small.

The lens unit 100D in this embodiment is capable of attaining similar effects to the lens units 100 and 100C in the first and fourth embodiments in the portions having the same structures as the lens units 100 and 100C in the first and fourth embodiments.

### Sixth Embodiment

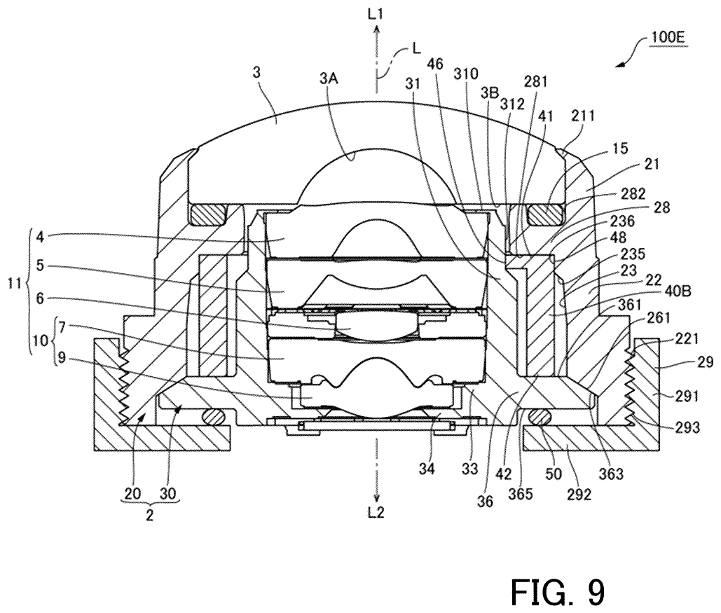

FIG. 9 is a sectional view showing a lens unit 100E in accordance with a sixth embodiment of the present invention. As shown in FIG. 9, in the lens unit 100E in the sixth embodiment, a shape of a spacer 40B is different from that of the lens unit 100C in the fourth embodiment. Therefore, in the sixth embodiment, the same reference symbols are used for the same structures as the fourth embodiment, and their explanations may be omitted.

As shown in FIG. 9, the first lens barrel member 20 is provided with a protruding part 235 in a ring shape which is protruded from an inner peripheral face 23 of an end portion on the object side “L1” of the second tube part 22 to an inner peripheral side.

As shown in FIG. 9, the spacer 40B is press-fitted to an inner side of the second tube part 22 of the first lens barrel member 20. In this case, an outer peripheral face 48 of an end portion on the object side “L1” of the spacer 40 contacts with an inner peripheral face 236 of the protruding part 235 in the radial direction.

As shown in FIG. 9, the spacer 40B is provided on an inner peripheral face of its end portion on the object side “L1” with a plurality of ribs 46 which are protruded to an inner side in the radial direction and are separately disposed from each other in a circumferential direction. In this embodiment, the spacer 40B has the same shape as the spacer 40A in the third embodiment, but its disposed direction is different. Therefore, in this embodiment, the ribs 46 are provided at four positions.

The second lens barrel member 30 is lightly press-fitted to an inner side of the spacer 40B. In this case, an outer peripheral face 312 of an end portion on the object side “L1” of the main body tube 31 contacts with the ribs 46 in the radial direction. Further, when viewed in a direction perpendicular to the optical axis direction, the protruding part 235 and the ribs 46 are disposed at the position coincided in the radial direction. As a result, the second lens barrel member 30 is positioned with respect to the first lens barrel member 20 in the radial direction through the spacer 40B.

### Operations and Effects

According to the lens unit 100E in this embodiment, the second lens barrel member 30 is lightly press-fitted to an inner side of the spacer 40B. Therefore, even in a case that the second lens barrel member 30 is positioned with respect to the first lens barrel member 20 in the radial direction through the spacer 40B, the second lens barrel member 30 is capable of moving in the optical axis direction on an inner side of the spacer 40B even if a force applied to the second lens barrel member 30 in the optical axis direction is small.

The lens unit 100E in the sixth embodiment is capable of attaining similar effects to the lens units 100 and 100C in the first and fourth embodiments in the portions having the same structures as the lens units 100 and 100C in the first and fourth embodiments.

### Modified Embodiments

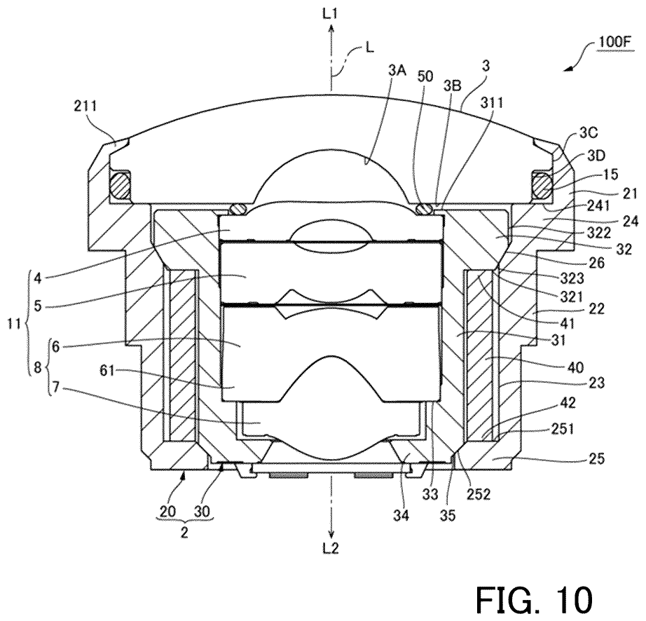

FIG. 10 is a sectional view showing a lens unit 100F in accordance with a modified embodiment of the present invention. As shown in FIG. 10, an elastic member 50 may be disposed between the first lens 3 and the second lens 4. In the lens unit 100F in this embodiment, similar effects to the lens unit 100 in the first embodiment can be attained.

In the embodiments described above, the spacer 40 is provided with the cut-out parts 43 and 44. However, the spacer 40 may be provided with no cut-out part.

In the lens unit 100A in the second embodiment, a plurality of ribs disposed in a circumferential direction may be provided on the inner peripheral face 232 of the protruding part 231 so as to contact with the outer peripheral face 322 of the flange part 32.

In the lens unit 100D in the fifth embodiment, a plurality of ribs disposed in a circumferential direction may be provided on the inner peripheral face 233 so as to contact with the outer peripheral face 362 of the flange part 36.

Embodiments of the present invention may be structured as follows.
(1) A lens unit including a first unit having a first lens and a first lens barrel member accommodating the first lens, a second unit having a second lens disposed on an image side with respect to the first lens and a second lens barrel member which accommodates the second lens and is held on an inner peripheral side of the first lens barrel member, a spacer in a tube shape which is disposed on an inner side of the first lens barrel member and is made of material whose linear expansion coefficient is higher than those of the first lens barrel member and the second lens barrel member, and an elastic member in a ring shape which is disposed on an inner side of the first lens barrel member. The first lens barrel member is provided with a first stepped part in a ring shape which is protruded from its inner peripheral side to an inner side in a radial direction, and the second lens barrel member is provided with a second stepped part in a ring shape which is protruded from its outer peripheral side to an outer side in the radial direction. The first stepped part is provided with a first face part facing one of an object side and an image side, and the second stepped part is provided with a second face part which faces the other of the object side and the image side and faces the first face part. The spacer is disposed between the first stepped part and the second stepped part and contacts with the first face part and the second face part, and the elastic member is disposed on an opposite side to a side where the spacer is disposed with respect to the second stepped part in an optical axis direction along an optical axis of the first lens and contacts with the first unit and the second unit in an elastically deformed state in the optical axis direction. When temperature of the first lens barrel member, second lens barrel member and spacer becomes higher, the spacer thermally expands in the optical axis direction and pushes the second lens barrel member to a side where the elastic member is disposed, and the second lens barrel member is moved to the side where the elastic member is disposed by crushing the elastic member in the optical axis direction. Further, when the temperature of the first lens barrel member, second lens barrel member and spacer becomes lower, the spacer thermally shrinks in the optical axis direction and thereby, the elastic member is restored in the optical axis direction, and the second lens barrel member is moved to the side where the spacer is disposed by the elastic member restored in the optical axis direction.
(2) The lens unit described in the above-mentioned structure (1), where the first stepped part is provided in a portion on the image side of the first lens barrel member, the first face part faces the object side, the second stepped part is provided in a portion on the object side of the second lens barrel member, the second face part faces the image side, and the second lens barrel member is inserted into an inner side of the first lens barrel member from the object side.
(3) The lens unit described in the above-mentioned structure (1) or (2), where the first stepped part is provided with a first inclined face which is inclined from an inner peripheral end of the first face part toward an opposite side to a side where the elastic member is disposed and from an outer side in a radial direction to an inner side in the radial direction, the second stepped part is provided with a second inclined face which is inclined from an outer peripheral end of the second face part toward a side where the elastic member is disposed and from an inner side in the radial direction to an outer side in the radial direction, the first lens barrel member is provided on its inner peripheral face with a first contact face which is an inclined face corresponding to the second inclined face and contacts with the second inclined face, the second lens barrel member is provided on its outer peripheral face with a second contact face which is an inclined face corresponding to the first inclined face and contacts with the first inclined face and, when the second lens barrel member is disposed on an inner side of the first lens barrel member, the first inclined face and the second contact face contact with each other and the second inclined face and the first contact face contact each other and thereby, the second lens barrel member is positioned with respect to the first lens barrel member in the radial direction.
(4) The lens unit described in one of the above-mentioned structures (1) through (3), where the spacer is provided with a plurality of ribs, which are disposed in a circumferential direction and are protruded to an inner side in the radial direction, on an inner peripheral face of an end portion on an opposite side to a side where the elastic member is disposed, the spacer is press-fitted to an inner side of the first lens barrel member by contacting an outer peripheral face of the end portion of the spacer with an inner peripheral face of the first lens barrel member, the second lens barrel member is lightly press-fitted to an inner side of the spacer by contacting an outer peripheral face of the second lens barrel member with the ribs, and the spacer is press-fitted to the inner side of the first lens barrel member and the second lens barrel member is lightly press-fitted to the inner side of the spacer and thereby, the second lens barrel member is positioned with respect to the first lens barrel member in the radial direction through the spacer.
(5) The lens unit described in one of the above-mentioned structures (1) through (3), where the second stepped part is provided with a first outer peripheral face which is linearly extended from an outer peripheral end of the second face part to the object side, the first lens barrel member is provided on its inner peripheral face with a first contact face contacting with the first outer peripheral face in the radial direction, the second lens barrel member is lightly press-fitted to the inner peripheral side of the first lens barrel member by contacting the first outer peripheral face with the first contact face, and the second lens barrel member is lightly press-fitted to the inner side of the first lens barrel member and thereby, the second lens barrel member is positioned with respect to the first lens barrel member in the radial direction.
(6) The lens unit described in the above-mentioned structure (5), where the first stepped part is provided with a first inclined face which is inclined from an inner peripheral end of the first face part toward an opposite side to a side where the elastic member is disposed and from an outer side in a radial direction to an inner side in the radial direction, the second lens barrel member is provided on its outer peripheral face with a second contact face which is an inclined face corresponding to the first inclined face and contacts with the first inclined face, and the second lens barrel member is lightly press-fitted to an inner side of the first lens barrel member and the first inclined face contacts with the second contact face and thereby, the second lens barrel member is positioned with respect to the first lens barrel member in the radial direction.
(7) The lens unit described in one of the above-mentioned structures (1) through (6), where the spacer and the elastic member are overlapped with each other in the optical axis direction when viewed in the optical axis direction.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A lens unit comprising:
a first unit comprising a first lens and a first lens barrel member accommodating the first lens;
a second unit comprising a second lens disposed on an image side with respect to the first lens and a second lens barrel member which accommodates the second lens and is held on an inner peripheral side of the first lens barrel member;
a spacer in a tube shape which is disposed on an inner side of the first lens barrel member and is made of material whose linear expansion coefficient is higher than those of the first lens barrel member and the second lens barrel member; and
an elastic member in a ring shape which is disposed on an inner side of the first lens barrel member;
wherein the first lens barrel member comprises a first stepped part in a ring shape which is protruded from its inner peripheral side to an inner side in a radial direction;
the second lens barrel member comprises a second stepped part in a ring shape which is protruded from its outer peripheral side to an outer side in the radial direction;
the first stepped part comprises a first face part which faces one of an object side and an image side;
the second stepped part comprises a second face part which faces an other of the object side and the image side and faces the first face part;
the spacer is disposed between the first stepped part and the second stepped part and contacts with the first face part and the second face part;
the elastic member is disposed on an opposite side to a side where the spacer is disposed with respect to the second stepped part in an optical axis direction along an optical axis of the first lens and contacts with the first unit and the second unit in an elastically deformed state in the optical axis direction;
when temperature of the first lens barrel member, the second lens barrel member and the spacer becomes higher, the spacer thermally expands in the optical axis direction and pushes the second lens barrel member to a side where the elastic member is disposed, and the second lens barrel member is moved to the side where the elastic member is disposed by crushing the elastic member in the optical axis direction; and
when the temperature of the first lens barrel member, the second lens barrel member and the spacer becomes lower, the spacer thermally shrinks in the optical axis direction and thereby, the elastic member is restored in the optical axis direction, and the second lens barrel member is moved to the side where the spacer is disposed by the elastic member restored in the optical axis direction.

2. The lens unit according to claim 1, wherein
the first stepped part is provided in a portion on the image side of the first lens barrel member,
the first face part faces the object side,
the second stepped part is provided in a portion on the object side of the second lens barrel member,
the second face part faces the image side, and
the second lens barrel member is inserted into an inner side of the first lens barrel member from the object side.

3. The lens unit according to claim 1, wherein
the first stepped part comprises a first inclined face which is inclined from an inner peripheral end of the first face part toward an opposite side to a side where the elastic member is disposed and is inclined from an outer side in a radial direction to an inner side in the radial direction,
the second stepped part comprises a second inclined face which is inclined from an outer peripheral end of the second face part toward a side where the elastic member is disposed and is inclined from an inner side in the radial direction to an outer side in the radial direction,
the first lens barrel member comprises a first contact face on its inner peripheral face which is an inclined face corresponding to the second inclined face and contacts with the second inclined face,
the second lens barrel member comprises a second contact face on its outer peripheral face which is an inclined face corresponding to the first inclined face and contacts with the first inclined face, and
when the second lens barrel member is disposed on an inner side of the first lens barrel member, the first inclined face and the second contact face contact with each other, and the second inclined face and the first contact face contact each other and thereby, the second lens barrel member is positioned with respect to the first lens barrel member in the radial direction.

4. The lens unit according to claim 1, wherein
the spacer comprises a plurality of ribs, which are disposed in a circumferential direction and are protruded to an inner side in the radial direction, on an inner peripheral face of an end portion on an opposite side to a side where the elastic member is disposed,
the spacer is press-fitted to an inner side of the first lens barrel member by contacting an outer peripheral face of the end portion of the spacer with an inner peripheral face of the first lens barrel member,
the second lens barrel member is lightly press-fitted to an inner side of the spacer by contacting an outer peripheral face of the second lens barrel member with the ribs, and
the spacer is press-fitted to the inner side of the first lens barrel member and the second lens barrel member is lightly press-fitted to the inner side of the spacer and thereby, the second lens barrel member is positioned with respect to the first lens barrel member in the radial direction through the spacer.

5. The lens unit according to claim 1, wherein
the second stepped part comprises a first outer peripheral face which is linearly extended from an outer peripheral end of the second face part to the object side,
the first lens barrel member comprises a first contact face on its inner peripheral face which contacts with the first outer peripheral face in the radial direction,
the second lens barrel member is lightly press-fitted to the inner peripheral side of the first lens barrel member by contacting the first outer peripheral face with the first contact face, and
the second lens barrel member is lightly press-fitted to the inner side of the first lens barrel member and thereby, the second lens barrel member is positioned with respect to the first lens barrel member in the radial direction.

6. The lens unit according to claim 5, wherein
the first stepped part comprises a first inclined face which is inclined from an inner peripheral end of the first face part toward an opposite side to a side where the elastic member is disposed and from an outer side in the radial direction to an inner side in the radial direction,
the second lens barrel member comprises a second contact face on its outer peripheral face which is an inclined face corresponding to the first inclined face and contacts with the first inclined face, and
the second lens barrel member is lightly press-fitted to an inner side of the first lens barrel member and the first inclined face contacts with the second contact face and thereby, the second lens barrel member is positioned with respect to the first lens barrel member in the radial direction.

7. The lens unit according to claim 1, wherein the spacer and the elastic member are overlapped with each other in the optical axis direction when viewed in the optical axis direction.

8. The lens unit according to claim 2, wherein
the first stepped part comprises a first inclined face which is inclined from an inner peripheral end of the first face part toward an opposite side to a side where the elastic member is disposed and is inclined from an outer side in a radial direction to an inner side in the radial direction,
the second stepped part comprises a second inclined face which is inclined from an outer peripheral end of the second face part toward a side where the elastic member is disposed and is inclined from an inner side in the radial direction to an outer side in the radial direction,
the first lens barrel member comprises a first contact face on its inner peripheral face which is an inclined face corresponding to the second inclined face and contacts with the second inclined face,
the second lens barrel member comprises a second contact face on its outer peripheral face which is an inclined face corresponding to the first inclined face and contacts with the first inclined face, and
when the second lens barrel member is disposed on an inner side of the first lens barrel member, the first inclined face and the second contact face contact with each other, and the second inclined face and the first contact face contact each other and thereby, the second lens barrel member is positioned with respect to the first lens barrel member in the radial direction.

9. The lens unit according to claim 8, wherein
the spacer comprises a plurality of ribs, which are disposed in a circumferential direction and are protruded to an inner side in the radial direction, on an inner peripheral face of an end portion on an opposite side to a side where the elastic member is disposed,
the spacer is press-fitted to an inner side of the first lens barrel member by contacting an outer peripheral face of the end portion of the spacer with an inner peripheral face of the first lens barrel member,
the second lens barrel member is lightly press-fitted to an inner side of the spacer by contacting an outer peripheral face of the second lens barrel member with the ribs, and
the spacer is press-fitted to the inner side of the first lens barrel member and the second lens barrel member is lightly press-fitted to the inner side of the spacer and thereby, the second lens barrel member is positioned with respect to the first lens barrel member in the radial direction through the spacer.

10. The lens unit according to claim 2, wherein
the second stepped part comprises a first outer peripheral face which is linearly extended from an outer peripheral end of the second face part to the object side,
the first lens barrel member comprises a first contact face on its inner peripheral face which contacts with the first outer peripheral face in the radial direction,
the second lens barrel member is lightly press-fitted to the inner peripheral side of the first lens barrel member by contacting the first outer peripheral face with the first contact face, and
the second lens barrel member is lightly press-fitted to the inner side of the first lens barrel member and thereby, the second lens barrel member is positioned with respect to the first lens barrel member in the radial direction.

11. The lens unit according to claim 10, wherein
the first stepped part comprises a first inclined face which is inclined from an inner peripheral end of the first face part toward an opposite side to a side where the elastic member is disposed and from an outer side in the radial direction to an inner side in the radial direction,
the second lens barrel member comprises a second contact face on its outer peripheral face which is an inclined face corresponding to the first inclined face and contacts with the first inclined face, and
the second lens barrel member is lightly press-fitted to an inner side of the first lens barrel member and the first inclined face contacts with the second contact face and thereby, the second lens barrel member is positioned with respect to the first lens barrel member in the radial direction.

12. The lens unit according to claim 2, wherein
the spacer comprises a plurality of ribs, which are disposed in a circumferential direction and are protruded to an inner side in the radial direction, on an inner peripheral face of an end portion on an opposite side to a side where the elastic member is disposed,
the spacer is press-fitted to an inner side of the first lens barrel member by contacting an outer peripheral face of the end portion of the spacer with an inner peripheral face of the first lens barrel member,
the second lens barrel member is lightly press-fitted to an inner side of the spacer by contacting an outer peripheral face of the second lens barrel member with the ribs, and
the spacer is press-fitted to the inner side of the first lens barrel member and the second lens barrel member is lightly press-fitted to the inner side of the spacer and thereby, the second lens barrel member is positioned with respect to the first lens barrel member in the radial direction through the spacer.

13. The lens unit according to claim 3, wherein
the second stepped part comprises a first outer peripheral face which is linearly extended from an outer peripheral end of the second face part to the object side,
the first lens barrel member comprises a first contact face on its inner peripheral face which contacts with the first outer peripheral face in the radial direction,
the second lens barrel member is lightly press-fitted to the inner peripheral side of the first lens barrel member by contacting the first outer peripheral face with the first contact face, and
the second lens barrel member is lightly press-fitted to the inner side of the first lens barrel member and thereby, the second lens barrel member is positioned with respect to the first lens barrel member in the radial direction.

14. The lens unit according to claim 13, wherein
the first stepped part comprises a first inclined face which is inclined from an inner peripheral end of the first face part toward an opposite side to a side where the elastic member is disposed and from an outer side in the radial direction to an inner side in the radial direction,
the second lens barrel member comprises a second contact face on its outer peripheral face which is an inclined face corresponding to the first inclined face and contacts with the first inclined face, and
the second lens barrel member is lightly press-fitted to an inner side of the first lens barrel member and the first inclined face contacts with the second contact face and thereby, the second lens barrel member is positioned with respect to the first lens barrel member in the radial direction.

15. The lens unit according to claim 3, wherein
the spacer comprises a plurality of ribs, which are disposed in a circumferential direction and are protruded to an inner side in the radial direction, on an inner peripheral face of an end portion on an opposite side to a side where the elastic member is disposed,
the spacer is press-fitted to an inner side of the first lens barrel member by contacting an outer peripheral face of the end portion of the spacer with an inner peripheral face of the first lens barrel member,
the second lens barrel member is lightly press-fitted to an inner side of the spacer by contacting an outer peripheral face of the second lens barrel member with the ribs, and
the spacer is press-fitted to the inner side of the first lens barrel member and the second lens barrel member is lightly press-fitted to the inner side of the spacer and thereby, the second lens barrel member is positioned with respect to the first lens barrel member in the radial direction through the spacer.
